(19) United States
(12) Patent Application Publication
(10) Pub. No.: US 2006/0206723 A1
(43) Pub. Date: Sep. 14, 2006

(54) Method and system for integrated authentication using biometrics

(76) Inventors: Youn Hee Gil, Daejeon-city (KR); Yun Su Chung, Daejeon-city (KR); Ki Hyun Kim, Daejeon-city (KR); Jang Hee Yoo, Daejeon-city (KR); Kyo Il Chung, Daejeon (KR); Dosung Ahn, Gyeonggi-do (KR); Sung Bum Pan, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/294,785

(22) Filed: Dec. 6, 2005

(30) Foreign Application Priority Data
Dec. 7, 2004 (KR) 10-2004-0102504
May 31, 2005 (KR) 10-2005-0046461
Nov. 18, 2005 (KR) 10-2005-0110819

(51) Int. Cl. H04K 1/00

(52) U.S. Cl. 713/186

(57) ABSTRACT

Provided are an integrated authentication method and system using biometrics. In an integrated authentication system including a client, a plurality of service providing servers where user identification information of the client is registered, and an integrated server where user biometric information together with the user identification information is registered, to integratedly authenticate access of the client to the service providing servers, the client acquires authentication of access to a first service providing server by using the user biometric information and the user identification information through the integrated sever. When the access is permitted, the client receives a first access permission message generated by the first service providing server and stores the first access permission message. The client acquires authentication of access to a second service providing server by using the first access permission message and the user identification information.

### CROSS-REFERENCE TO RELATED PATENT APPLICATION

This application claims the benefit of Korean Patent Applications No. 10-2004-0102504, filed on Dec. 7, 2004, 10-2005-0046461, filed on May 31, 2005, and 10-2005-0110819, filed on Nov. 18, 2005, in the Korean Intellectual Property Office, the disclosures of which are incorporated herein in their entirety by reference.

### BACKGROUND OF THE INVENTION

1. Field of the Invention

The present invention relates to an integrated authentication method and system using biometrics, and more particularly, to an integrated authentication method and system using biometrics, which reduce user's inconvenience and provide high security by accessing a plurality of service providing servers via only user identification information and user biometric information. In addition, the present invention relates to an integrated authentication method and system using biometrics, which automatically authenticate a user who intends to move from a service providing server to another service providing server in which the user is registered, as long as the user does not log out of a web site.

2. Description of Related Art

Recently, as the Internet has become more popular, many Internet related applications such as electronic commerce and electronic banking are being widely used. Accordingly, the protection of personal information and privacy has become very important. Therefore, there is a need to securely manage personal IDs and passwords.

In general, many users who are registered in a plurality of Internet sites use the same ID and password for authentication. In this situation, if one of the Internet sites has a weak security system and is attacked by a hacker, user's information may be illegitimately acquired, so that a serious privacy protection problem may occur.

To avoid this problem, some users use different IDs and passwords for different Internet sites. However, since the user has to look for the right ID and password among a plurality of IDs and passwords, it may take too much time to access a specific Internet site.

After activating an explorer, every time that the user intends to move from a service providing server to other service providing servers, the user must perform an authentication process for the new service providing server. In this case, if the IDs and passwords registered in the other service providing servers are different from each other, the user must input a new ID and password. On the other hand, even though the same ID and password are registered in the other service providing servers, the access processes are independently performed, so that the user must input the ID and password anyway.

To solve this problem, there has been proposed an ID federation technique in which an integrated server manages IDs to federate a plurality of IDs of a user, which are registered in a plurality of the service providing servers into a signal ID.

The ID federation technique has an advantage in that there is no need for an additional authentication process when a user accessing a service providing server intends to access another service providing server. However, the user must perform a registration process to register the service providing servers and the IDs and passwords therefor in the integrated server in advance. Thus, a hacker could obtain the IDs and passwords when this process is being performed.

To solve the problem of the ID federation technique, there has been proposed a technique of performing authentication by using biometric information unique to individual users such as fingerprints and face images. However, when the biometric information is obtained by an authorized party, even more serious problems may occur. Also, since the biometric information may be lost or stolen while being transmitted to or stored in sites other than permitted servers, there is a need for a technique of performing authentication without using the original biometric information.

### SUMMARY OF THE INVENTION

The present invention provides an integrated authentication method and system using biometrics, which perform authentication for an Internet site using biometric information instead of a password and automatically authenticate a user who intends to move from an Internet site to another Internet site in which the user is registered as long as the user does not log out of the first web site.

The present invention provides an integrated authentication method and system using biometrics, which perform a, distributed authentication process by transmitting to a plurality of service providing servers user biometric information regenerated from user biometric information stored in an integrated server according to an inverse-transformation-impossible scheme, without the integrated server performing authentication when a client intends to access the plurality of the service providing servers.

According to an aspect of the present invention, there is provided a method of registering user identification information from a client with a service providing server by using biometrics in an integrated authentication system having the client, the service providing server, and an integrated server, the method including: (a) the service providing server transmitting the user identification information requested by the client to the integrated server and requesting the integrated server to check whether or not the user identification information is registered in the integrated server; (b) the integrated server transmitting a user biometric information input request message to the client, comparing user biometric information input from the client to user biometric information which is mapped to the user identification information transmitted from the service providing server and registered in the integrated server to authenticate the client, and if the authentication succeeds, transmitting a user identification information registration checking success message to the service providing server; and (c) the service providing server registering the user identification information requested by the client.

According to another aspect of the present invention, there is provided a method of authenticating access of a client to a service providing server by using biometrics in an integrated authentication system having the client, the service providing server where user identification information of the client is registered, and the integrated server, the method including: (a) the client transmitting the user identification information to the service providing server to request the access to the service providing server; (b) the service providing server transmitting the user identification information to the integrated server to request the integrated server to check whether or not the user identification information is registered; (c) the integrated server transmitting a user biometric information input request message to the client, comparing user biometric information input from the client to user biometric information which is mapped to the user identification information transmitted from the service providing server and registered to authenticate the client, and if the authentication succeeds, transmitting a user identification information registration checking success message to the service providing server; and (d) the service providing server authenticating the access of the client.

According to another aspect of the present invention, there is provided a method of authenticating access of a client to a service providing server by using biometrics in an integrated authentication system having the client, the service providing server where user identification information of a client is registered, and an integrated server where user biometric information together with the user identification information is registered, the method including: (a) the client transmitting the user identification information to the service providing server to request the access; (b) the service providing server transmitting the user identification information to the integrated serer to request the user biometric information; (c) the integrated server regenerating user biometric information which is mapped to the user identification information and registered and transmitting the regenerated user identification information and a regeneration scheme to the service providing server; and (d) the service providing server transmitting a user biometric information input request message, comparing the regenerated user biometric information transmitted from the client to the regenerated user biometric information transmitted from the integrated server to authenticate the client, and determining whether or not the authentication succeeds, and authenticating the access of the client if the authentication is successful.

According to another aspect of the present invention, there is provided a method of integratedly authenticating access of a client to a plurality of service providing servers by using biometrics in an integrated authentication system having the client, the plurality of service providing servers where user identification information of the client is registered, and an integrated server, the method including: (a) the client acquiring authentication of access to a first service providing server by using the user biometric information and the user identification information through user authentication of the integrated server; (b) when the access is permitted in the (a), the client receiving a first access permission message generated by the first service providing server and storing the first access permission message; and (c) the client acquiring authentication of access to a second service providing server by using the first access permission message and the user identification information.

According to another aspect of the present invention, there is provided a method of integratedly authenticating access of a client to a plurality of service providing servers by using biometrics in an integrated authentication system having the client, the plurality of service providing servers where user identification information of the client is registered, and an integrated server where user biometric information together with the user identification information is registered, the method comprising: (a) the client acquiring authentication of access to a first service providing server by using the user biometric information and the user identification information through a user biometric information regeneration scheme of the integrated server; (b) when the access is permitted in the (a), the client receiving a first access permission message generated by the first service providing server and storing the first access permission message; and (c) the client acquiring authentication of access to a second service providing server by using the first access permission message and the user identification information.

According to another aspect of the present invention, there is provided an integrated authentication system comprising: a client which receives the user identification information and an input of user biometric information through a biometric information input machine, transmits the user biometric information and the user identification information to the integrated server to acquire registration, and accesses the service providing server by using the user identification information; a service providing server which checks whether or the user identification information is stored in the integrated server when the access request message including the user identification information is transmitted from the client and, after the checking, authenticates the access of the client; and an integrated server which registers the user biometric information and the user identification information transmitted from the client, requests the client to input the user biometric information when a user identification information checking request message is transmitted from the service providing server, compares the user biometric information input from the client to user biometric information stored in the integrated server to authenticate the client, and when authentication succeeds, transmits a user identification information checking success message to the service providing server.

According to another aspect of the present invention, there is provided an integrated authentication system comprising: a client which transmits to the integrated server the user identification information and user biometric information matching with the user identification information to acquire registration and accesses the service providing server by using the user identification information; an integrated server which detects the user biometric information matching with the user identification information and regenerates user biometric information when a user biometric information request message including the user identification information is transmitted, and transmits the regenerated user biometric information to the service providing server; and a service providing server which transmits the user identification information to the integrated server when an access request message including the user identification information is transmitted, compares the regenerated user biometric information transmitted from the integrated server to user biometric information regenerated according to a regeneration scheme that is the same as a regeneration scheme received from the client by request, and authenticates the access of the client.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a construction of an integrated authentication system using biometrics according to an embodiment of the present invention;

FIG. 2A is a detailed view showing an example of the construction of the integrated authentication system using biometrics shown in FIG. 1;

FIG. 2B is a detailed view showing another example of the construction of the integrated authentication system using biometrics shown in FIG. 1;

FIGS. 3A to 3D shows a fingerprint characteristic point acquisition process for fingerprint recognition as an example of biometrics used in FIG. 1;

FIG. 4 is a flowchart showing a method of registering user identification information and user biometric information in an integrated server by using the biometrics, according to an embodiment of the present invention;

FIG. 5 is a flowchart showing a method of registering the user identification information shown in FIG. 4 in the service providing server;

FIGS. 6A and 6B are flowcharts showing, an integrated authentication method using biometrics for accessing a plurality of service providing servers, according to an embodiment of the present invention;

FIGS. 7A and 7B are flowcharts showing an integrated authentication method using biometrics for accessing a plurality of service providing servers, according to another embodiment of the present invention;

FIGS. 8A and 8B show a fingerprint characteristic point acquisition process for fingerprint recognition as an example of biometrics used in FIGS. 2B or 7A and 7B.

### DETAILED DESCRIPTION OF THE INVENTION

Hereinafter, the present invention will be described in detail by explaining exemplary embodiments of the invention with reference to the attached drawings. Hereinafter, the present invention will be described in detail by explaining exemplary embodiments of the invention with reference to the attached drawings.

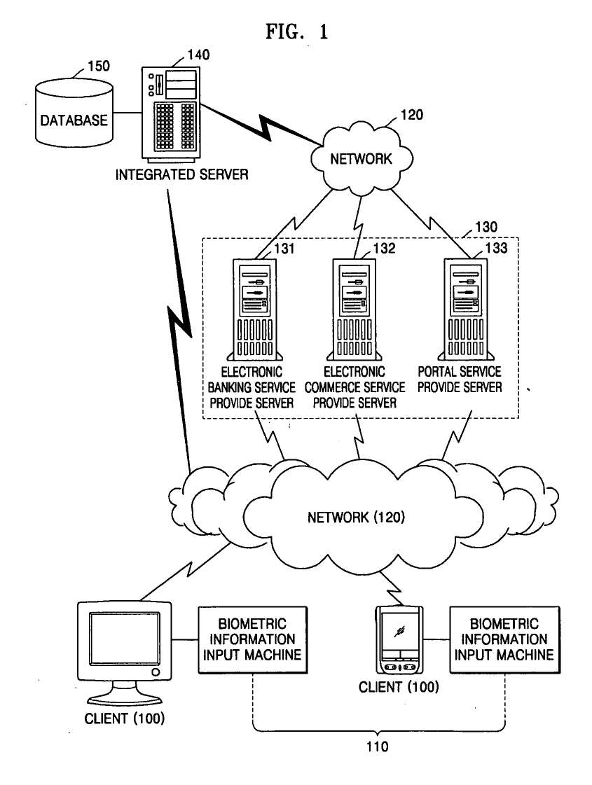

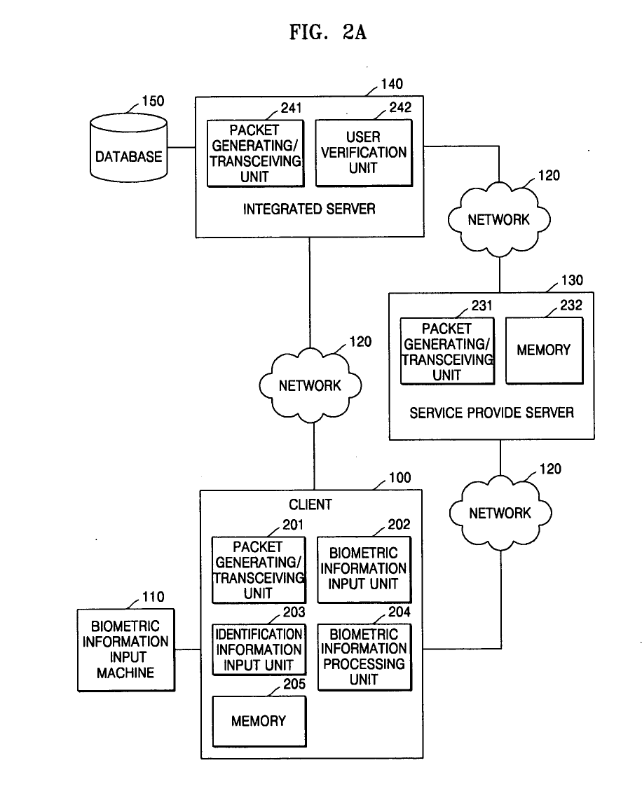

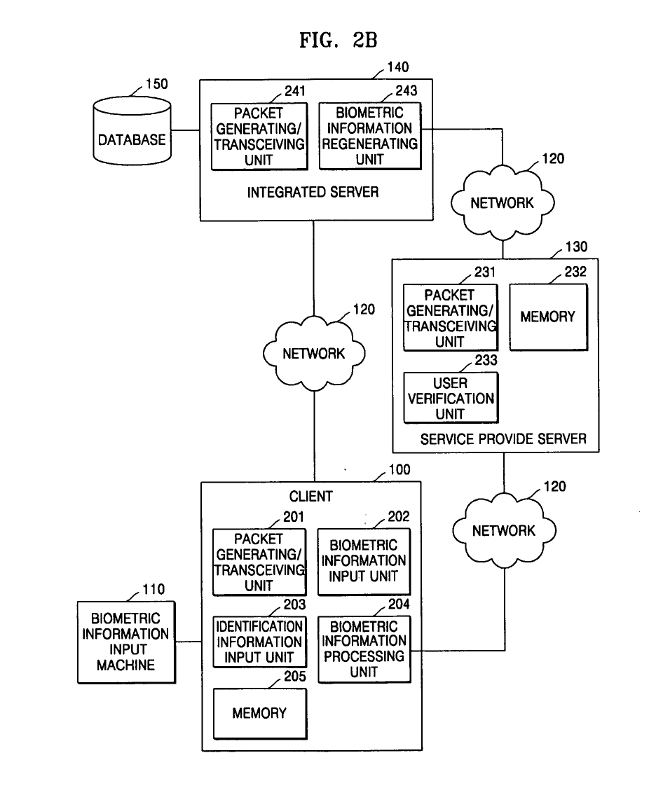

FIG. 1 is a view showing a construction of an integrated authentication system using biometrics according to an embodiment of the present invention. FIG. 2A is a detailed view showing an example of the construction of the integrated authentication system using biometrics shown in FIG. 1. FIG. 2B is a detailed view showing another example of the construction of the integrated authentication system using biometrics shown in FIG. 1.

Referring to FIG. 1, the authentication system using biometrics includes a client 100, a biometric information input machine 110, a service providing server 130, an integrated server 140, an a database 150.

Referring to FIG. 2A, according to an embodiment of the present invention, the client 100 includes a packet generating/transceiving unit 201, a biometric information input unit 202, an identification information input unit 203, a biometric information processing unit 204, and a memory 205.

The client 100 has access to the service providing server 130 and the integrated server 140 through the network 120 using a personal computer (PC), a laptop computer, or the like. More specifically, the client 100 performs message transceiving from/to the service providing server 130 and the integrated server 140 by using the packet generating/transceiving unit 201.

The biometric information input machine 110 acquires user biometric information which includes user's various biological characteristics by using a fingerprint input machine, a camera, a microphone, or the like and provides the user biometric information to the biometric information input unit 202 of the client 100.

The identification information input unit 203 of the client 100 receives user identification information from a user who intends to access the service providing server 130 or the integrated server 140 through the client 100. The user identification information denotes all kinds of information by which the user can be identified, such as ID information, resident registration information, and the like. However, in order to distinguish the user identification information from the user biometric information acquired by using a biometrics technique, it is assumed that the user identification information does not include the user biometric information.

The biometric information processing unit 204 of the client 100 transforms the user biometric information input through the biometric information input unit 203 into a form which can be suitably used for verification purposes by using a signal processing method.

The service providing server 130 denotes a server of a company which provides various services through the network 120 to the client 100. The service providing server 130 transceives messages from/to the client 100 and the integrated server 140 by using the packet generating/transceiving unit 231.

Examples of the service providing server 130 include an electronic banking service providing server 131 which provides transaction services associated with banks or security companies, an electronic commerce service providing server 132 which provides electronic commerce services associated with Internet shopping malls companies, and a portal service providing server 133 which provides portal services and associated services of portal companies.

The service providing server 130 is not limited to the above exemples, and may include other service providing servers that are being developed or will be developed.

Meanwhile, although there is a great number of service providing servers, a few of them are reliable. In fact, a large number of service providing servers appear and disappear daily. In this situation, the user identification information and the user biometric information registered in the service providing servers may not be protected. Therefore, it is not preferable to provide the user biometric information as well as the user identification information to unreliable service providing servers to avoid loss or theft of the user biometric information.

Accordingly, there is a need for a reliable third party authentication server beside the service providing server 130. The integrated server 140 serves as a third party authentication server.

Practically, authentication organizations such as the Financial Telecommunications & Clearings Institute serve as the integrated server 140. The user identification information and the user biometric information transmitted from the client 100 are previously registered in a database 150 in the integrated server 140.

When receiving a request message for checking user identification information from the packet generating/transceiving unit 231 of the service providing server 130, the integrated server 140 requests the packet generating/transceiving unit 201 of the client 100 to input the user biometric information input and receives the input of the user biometric information. The user verification unit 242 of the integrated server 140 compares user biometric information registered in the database 150 to the user biometric information currently input from the packet generating/transceiving unit 201 of the client 100 to verify whether or not the client 100 is authentic.

When the verification succeeds, the packet generating/transceiving unit 241 of the integrated server 140 transmits a user identification information checking success message to the packet generating/transceiving unit 231 of the service providing server 130. In this case, the service providing server 130 registers the user identification information in the memory 232.

When the access is request by the client 100, the service providing server 130 requests the integrated server 140 to authenticate the user identification information, and the integrated server 140 authenticates the client 100 according to a user identification information registration checking success message indicating whether or not the user identification information is authenticated. In addition, when the access is authenticated, the service providing server 130 transmits an access permission message to the client 100.

The client 100 stores the access permission message transmitted from the service providing server 130 in the memory 205. In addition, when the client 100 intends to access a service providing server 130 other than the service providing server 130 receiving the access permission message, the client 100 transmits the access permission message and the user identification information so that the client 100 can access the other service providing server 130 without an additional login procedure through the integrated server 140.

The database 150 stores the user identification information and the user biometric information transmitted from the client 100 to the integrated server 140. The user identification information and the user biometric information are matched with each other and stored in the database 150. Accordingly, when the integrated server 140 issues a request, the user biometric information matching with the user identification information can be transmitted to the integrated server 140.

With regards to FIG. 2B only elements different from those shown in FIG. 2A will now be mainly described. Referring to FIG. 2B, the service provide server 130 includes a packet generating/transceiving unit 231, a memory 232, and a user verification unit 233, and the integrated server 140 includes a packet generating/transceiving unit 241 and a biometric information regenerating unit 242.

FIG. 2A refers to a case where the integrated server 140 performs user verification processes every time a large number of clients 100 try to access a large number of service providing servers 130. In this case, during the verification processes, the integrated sever 140 is overloaded, so that it may take much time to obtain user authentication. Therefore, as shown in FIG. 2B, a user verification unit 232 is included in the service providing server 130.

The integrated server 140 registers the user identification information and the user biometric information transmitted from the client 100 in the database 150 in advance.

When receiving a user identification information checking request message from the packet generating/transceiving unit 231 of the service providing server 130, the integrated server 140 checks whether or not the user is registered in the database 150 by using the user identification information. When the user is registered, the biometric information of the associated user is loaded, and the biometric information is processed and regenerated by the biometric information regenerating unit 243. The regenerated biometric information is transmitted to the service providing server 130 through the packet generating/transceiving unit 241.

As described above, the loss or theft of biometric information such as fingerprints and face images may cause serious problems. In general, since the biometric information may be lost or stolen while being transmitted to or stored in sites other than permitted servers, the original biometric information is not used. Accordingly, cancelable biometrics schemes have been proposed, by which the biometric information is subject to a transformation whose reverse transformation is impossible, to generate a new form of information different from the original biometric information. Therefore, when the integrated server 140 transmits the biometric information to the service providing server 130, the cancelable biometrics is regenerated from the biometric information in advance, so that the loss or theft of the original biometric information is prevented.

After receiving the checking message and the regenerated biometric information from the integrated server 140, the service providing server 130 requests the packet generating/transceiving unit 201 of the client 100 to input the user biometric information in order to receive the user biometric information regenerated according to a regeneration scheme which is equal to the regeneration scheme of the integrated server 140. The user verification unit 232 of the service providing server 130 compares the biometric information transmitted from the integrated server 140 to the biometric information transmitted from the client 100 to verify whether or not the client 100 is authentic. When the verification succeeds, the packet generating/transceiving unit 231 of the service providing server 130 transmits an access permission message to the client 100, and the access of the client 100 is authenticated.

When receiving the access permission message from the service providing server 130, the client 100 stores the transmitted access permission message in the memory 205. In addition, when the client 100 receiving the access permission message intends to access a service providing server 130 other than the service providing server 130, the client 100 transmits the access permission message and the user identification information to the other service providing server 130, so that the client 100 can access the other service providing server 130 without an additional login procedure.

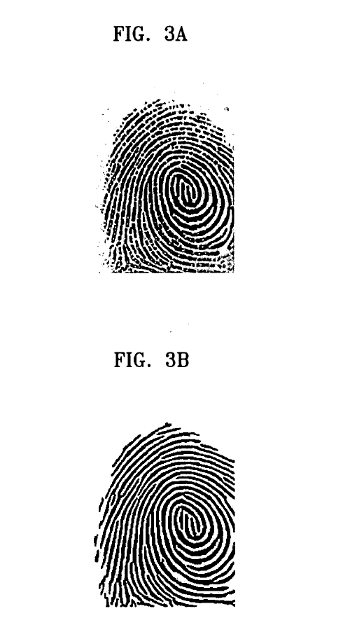

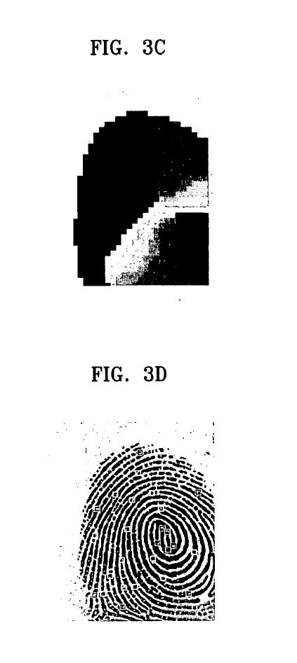

FIGS. 3A to 3D shows a fingerprint characteristic point acquisition process for fingerprint recognition as an example of biometrics used in FIG. 1. FIG. 3A shows an original fingerprint image acquired by a biometric information input machine, FIG. 3B shows a binary fingerprint image where noise is removed from the original fingerprint image, FIG. 3C shows a directionality map image obtained from the binary fingerprint image, and FIG. 3D shows an image indicating positions and directions of fingerprint characteristic points of the original fingerprint image.

More specifically, FIG. 3A shows the original fingerprint image of a user acquired by the biometric information input machine 110.

FIG. 3B shows the binary fingerprint image obtained by covering the original fingerprint image acquired in FIG. 3A with a specific filter to remove noise therefrom and performing binarization.

FIG. 3C shows the directional map image obtained by defining suitable blocks on the binary fingerprint image and checking directions of the defined blocks.

FIG. 3D shows the image indicating the positions, types, and directions of the fingerprint characteristic points on the original fingerprint image of FIG. 3A. The types and positions of the fingerprint characteristic points can be found by thinning the binary fingerprint image of FIG. 3B and covering the thinned ridges with a kernel.

FIGS. 3A to 3D show an example of using fingerprint information when processing user biometric information and acquiring characteristic points, but other types of user biometric information may be practically used. In addition, although the fingerprint information is used, other characteristics may be used.

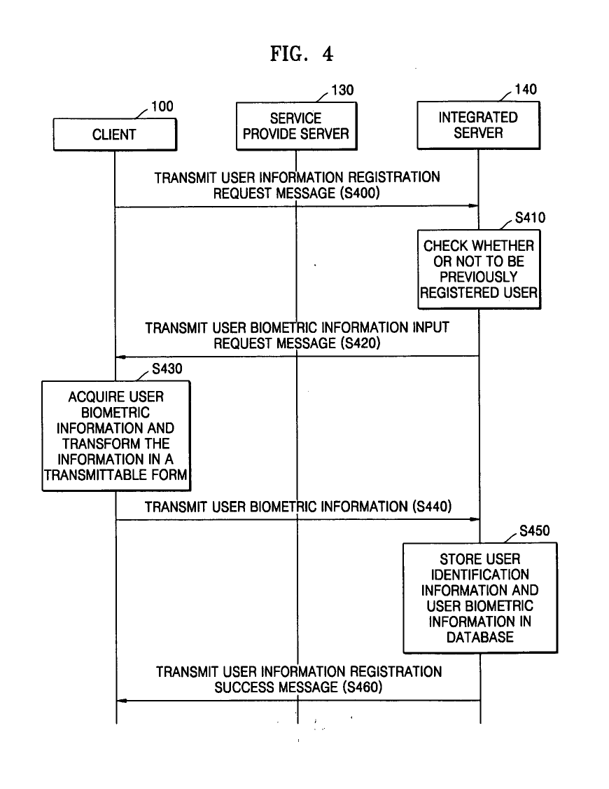

FIG. 4 is a flowchart showing a method of registering the user identification information and the user biometric information in the integrated server 140 by using the biometrics, according to an embodiment of the present invention. Referring to FIG. 4, a flow of transceiving messages among the client 100, the service providing server 130, and the integrated server 140 is shown.

In order for a user to be authenticated for an Internet site using user biometric information or perform automatic authentication switching to another site using the user biometric information, the user biometric information and the user identification information need to be pre-stored in a reliable integrated server 140. Therefore, before the user registration is performed in the service providing server 130, the user biometric information and the user identification information need to be registered in the integrated server 140.

Firstly, the client 100 transmits a user information registration request message to the integrated server 140 (S400). Here, the transmitted user information registration request message includes the user identification information.

Next, the integrated server 140 checks whether or not the user identification information is the user identification information previously registered in the integrated server 140 by using the user identification information, for example, a resident registration number, transmitted together with the user information registration request message (S410).

Next, when it is determined that the user identification information is not previously-registered user identification information, the integrated server 140 transmits a user biometric information input request message to the client 100 (S420).

Next, the client 100 acquires the user biometric information, performs preparation thereof, and transforms the user biometric information in such a form that the user biometric information can be transmitted to the integrated server 140 (S430).

Next, the client 100 transmits the user biometric information through the network 120 to the integrated server 140 (S440).

Next, the integrated server 140 performs mapping of the user biometric information transmitted in operation S440 and the user identification information transmitted in operation S400 and stores a result thereof in the database 150 (S450).

Next, the integrated server 140 transmits a user information registration success message to the client 100 (S460). By the aforementioned operations, the client 100 registers the user identification information and the user biometric information in the integrated server 140.

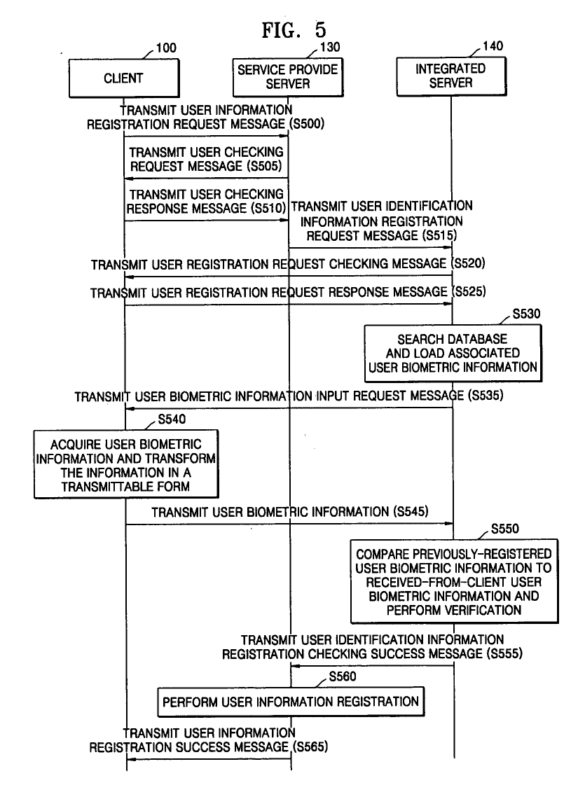

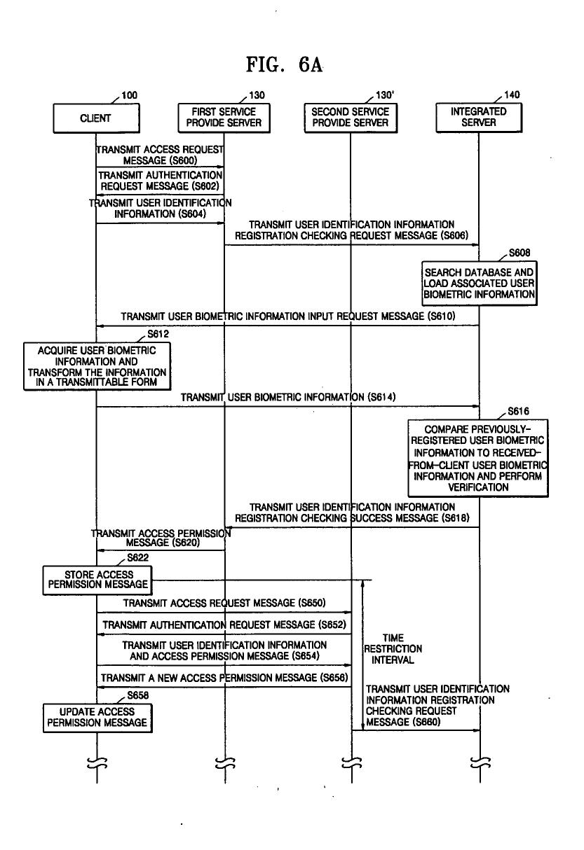

FIG. 5 is a flowchart showing a method of registering the user identification information shown in FIG. 4 in the service providing server 130. FIG. 5 shows a method of registering the user identification information and the user biometric information in the integrated server 140, and after that, registering the user identification information in the service providing server 130.

Firstly, the client 100 transmits a user information registration request message to a specific service providing server 130 (S500). Here, the transmitted user information registration request message includes the user identification information.

Next, the service providing server 130 transmits a user checking request message to the client 100 in order to check whether or not the user transmitting the user information registration request message by using the client 100 is the user previously registered in the integrated server 140 (S505).

Next, the client 100, after receiving the user checking request message, transmits a user checking response message to the integrated server 140 when the user identification information and the user biometric information have been previously registered (S510).

Next, the service providing server 130 transmits the user identification information and a user identification information registration checking request message to the integrated server 140 to check whether or not the user identification information has been previously registered in the integrated server 140 (S515). Here, although operation S515 follows operation S505 and operation S510, operation S515 may directly follow operation S500.

Next, the integrated server 140 transmits a registration request checking message to the client 100 again to check whether or not the client 100 intends to register the user identification information in the associated service providing server 130 (S520).

Next, the client 100 transmits a registration request response message to the integrated server 140 in order to inform that the client 100 intends to register to the service providing server 130 (S525). Here, operation S520 and operation S525 are performed by the integrated server 140 in order to securely check the client 100. In another embodiment of the present invention, operation S530 may directly follow operation S515.

Next, the integrated server 140 searches the database 150 to load the user biometric information stored therein so as to check if it matches with the user identification information (S530).

Next, the integrated server 140 transmits a user biometric information input request message to the client 100 (S535).

Next, the client 100 acquires the user biometric information, performs preparation thereof, and transforms the user biometric information in such a form that the user biometric information can be transmitted to the integrated server 140 (S540).

Next, the client 100 transmits the user biometric information through the network 120 to the integrated server 140 (S545).

Next, the integrated server 140 compares the user biometric information loaded in operation S530 to the user biometric information transmitted from the client 100 in operation S545 and performs verification (S550).

Next, when the verification is successful in operation S550, the integrated server 140 transmits a user identification information registration checking success message to the service providing server 130 (S555).

Next, the service providing server 130 stores the user identification information transmitted from the client 100 in operations S500 and performs the user information registration (S560).

Next, the service providing server 130 transmits a user information registration success message to the client 100 (S565).

Accordingly, the user identification information of the client 100 can be registered in the service providing server 130 through a reliable integrated server 140.

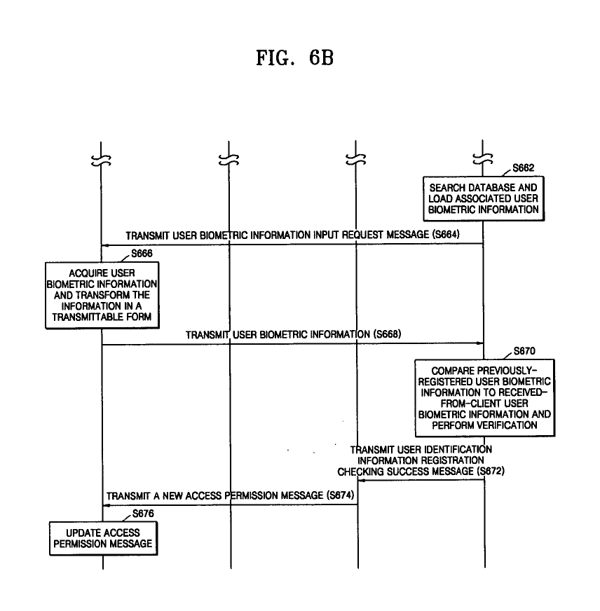

FIGS. 6A and 6B is a flowchart showing an integrated authentication method using biometrics for accessing a plurality of service providing servers, according to an embodiment of the present invention. FIGS. 6A and 6B show a message transceiving procedure performed among the client 100, the first service providing server 130, the second service providing server 130′, and the integrated server 140. In particular, the message transceiving procedure includes a message transceiving method performed for automatic authentication, when the client 100 moves to other service providing servers.

Here, the user identification information and the user biometric information have been previously registered in the integrated server 140, and the user identification information has been previously registered in the first and second service providing servers 130 and 130′. In FIGS. 6A and 6B, it is assumed that the user who is authenticated in the first service providing server 130 through the client 100 intends to be authenticated in the second service providing server 130′ without logging out of the first service providing server 130.

Firstly, the user transmits an access request message to the first service providing server 130 through the client 100 (S600).

Next, the first service providing server 130 transmits the authentication request message to the client 100 (S602). Here, the authentication request message is a message for requesting the client 100 for user identification information.

Next, the user transmits the user identification information to the first service providing server 130 through the client 100 (S604). Here, in operation S600, the access request message is transmitted to the first service providing server 130, and the first service providing server 130 requests the user identification information from the client 100. However, in operation S600, the user identification information together with the access request message may be transmitted.

Next, the first service providing server 130 transmits the user identification information and a user identification information registration checking request message to the integrated server 140 to check whether or not the user identification information is previously registered in the integrated server 140 (S606).

Next, the integrated server 140 searches the database 150 to load the user biometric information stored therein so as to check if it matches with the user identification information (S608).

Next, the integrated server 140 transmits a user biometric information input request message to the client (S610).

Next, the client 100 acquires the user biometric information, performs preparation thereof, and transforms the user biometric information in such a form that the user biometric information can be transmitted to the integrated server 140 (S612).

Next, the client 100 transmits the user biometric information through the network 120 to the integrated server 140 (S614).

Next, the integrated server 140 compares the user biometric information loaded in operation S608 to the user biometric information transmitted from the client 100 in operation S614 and performs verification (S616).

Next, when the verification is successful in operation S616, the integrated server 140 transmits a user identification information registration checking success message to the first service providing server 130 (S618).

Next, the first service providing ser 130 receiving the user identification information registration checking result message transmits an access permission message to the client 100 and authenticates the access of the client 100 (S620).

Next, the client 100 stores the access permission message in the memory 205 (S622).

After that, when the user intends to access the second service providing server 130′ through the client 100, the following operations are performed.

Firstly, the user transmits an access request message to the second service providing server 130′ through the client 100 (S650).

Next, the second service providing server 130′ transmits an authentication request message to the client 100 (S652).

Next, the client 100 transmits the user identification information and the access permission message to the second service providing server 130′ (S654).

Next, the second service providing server 130′ determines whether or not a time restriction interval for the access permission message has elapsed. If it is determined that the time restriction interval has not elapsed, the second service providing server 130′ transmits a new access permission message to the client 100 (S656). As a result, the client 100 can access the second service providing server 130′. Here, after the time restriction interval has elapsed, the user identification information registration checking must be performed by the integrated server 140.

After operation S656, the client 100 updates the access permission message with a new access permission message and stores the new access permission message in the memory 205 (S658).

On the other hand, after operation S654, the second service providing server 130′ determines whether or not the time restriction interval for the access permission message has elapsed. If it is determined that the time restriction interval has elapsed, the second service providing server 130′ transmits a user identification information registration checking request message to the integrated server 140 to check whether or not the user identification information has been previously registered (S660).

Next, the integrated server 140 searches the database 150 to load the user biometric information which is stored so as to match with the user identification information (S662).

Next, the integrated server 140 transmits a user biometric information input request message to the client 100 (S664).

Next, the client 100 acquires the user biometric information, performs preparation thereof, and transforms the user biometric information in such a form that the user biometric information can be transmitted to the integrated server 140 (S666).

Next, the client 100 transmits the user biometric information through the network 120 to the integrated server 140 (S668).

Next, the integrated server 140 compares the user biometric information loaded in operation S668 to the user biometric information transmitted from the client 100 in operation S614 and performs verification (S670).

Next, when the verification is obtained in operation S670, the integrated server 140 transmits a user identification information registration checking success message to the second first service providing server 130 (S672).

Next, the second service providing server 130′ receiving the user identification information registration checking result message transmits a new access permission message to the client 100 and authenticate the access (S674).

Next, the client 100 update the access permission message with the new access permission message and stores the new access message in the memory 205 (S676).

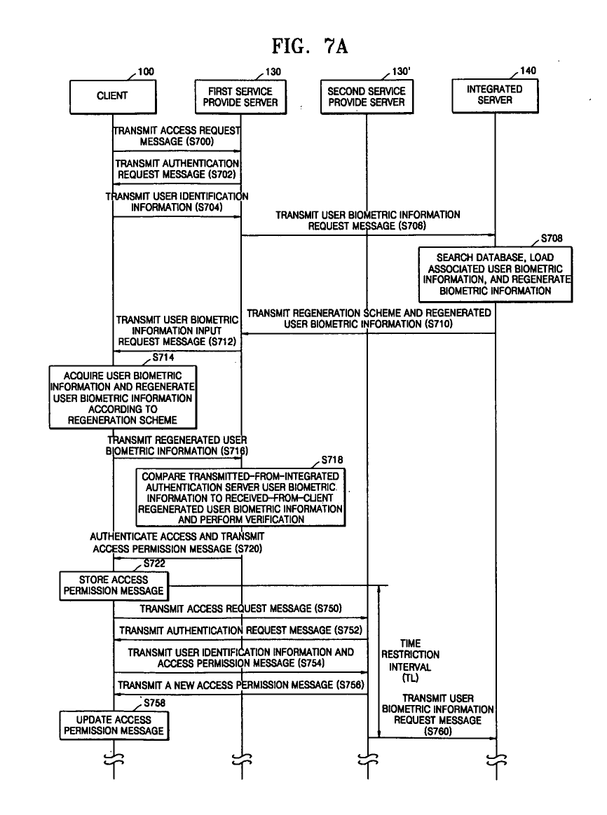

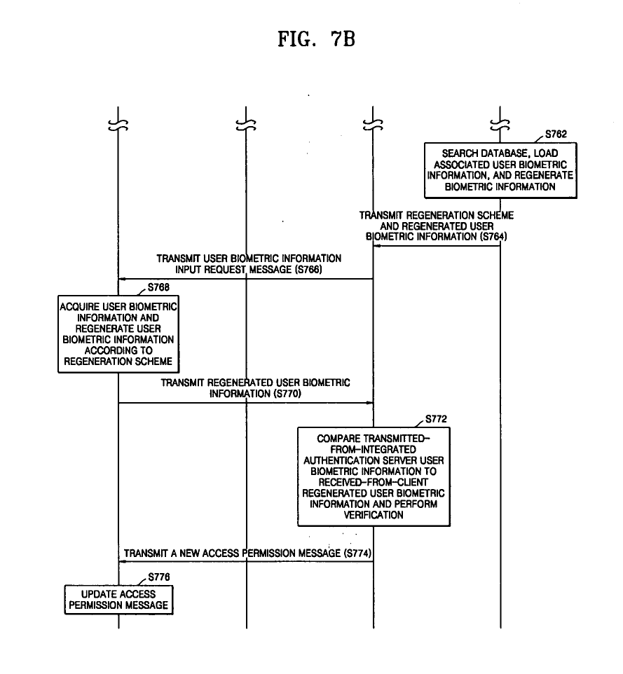

FIGS. 7A and 7B is a flowchart showing a method of integratedly authenticating access to a plurality of service providing servers by using biometrics according to another embodiment of the present invention. 7A and 7B show a message transceiving procedure performed among the client 100, the first service providing server 130, the second service providing server 130′, and the integrated server 140. In particular, the message transceiving procedure includes a message transceiving method performed for automatic authentication when the client 100 moves into different service providing servers.

Here, the user identification information and the user biometric information are previously registered in the integrated server 140, and the user identification information is previously registered in the different service providing server 130 and 130′. In FIGS. 7A and 7B, it is assumed that the user who is authenticated in the first service providing server 130 through the client 100 intends to be authenticated in the second service providing server 130′ without log out.

Firstly, the user transmits an access request message to the first service providing server 130 through the client 100 (S700).

Next, the first service providing server 130 transmits the authentication request message to the client 100 (S702). Here, the authentication request message is a message for requesting the user identification information from the client 100.

Next, the user transmits the user identification information to the first service providing server 130 through the client 100 (S704). Here, in operation S700, the access request message is transmitted to the first service providing server 130, and the first service providing server 130 requests the user identification information from the client 100. However, in operation S700, the user identification information may be transmitted together with the access request message.

Next, the first service providing server 130 transmits the user identification information to the integrated server 140 to request the user biometric information registered in the integrated server 140 (S706).

Next, the integrated server 140 searches the database 150 to load the user biometric information which is stored therein so as to check if it matches with the user identification information and regenerates the user biometric information from the loaded user biometric information through a different regeneration scheme (S708).

Next, the integrated server 140 transmits the regenerated user biometric information and the regeneration scheme to the client 100 (S710).

Next, the first service providing server 130 transmits a user biometric information input request message to the client 100 (S712). Here, the user biometric information input request message includes the regeneration scheme transmitted in operation S710.

Next, the client 100 regenerates the user biometric information through the regeneration scheme transmitted in operation S712 (S714).

Next, the client 100 transmits the regenerated user biometric information through the network 120 to the first service providing server 130 (S716).

Next, the first service providing server 130 compares the regenerated user biometric information transmitted from the integrated server 140 in operation S710 to the regenerated user biometric information transmitted from the client 100 in operation S716 and performs verification (S718).

Next, when the verification is successful in operation S718, the first service providing server 130 generates a first access permission message and transmits the generated first access permission message to the client 100, so that the client 100 is authenticated (S720).

Next, the client 100 stores the first access permission message in the memory 205 (S722).

Subsequently, when the user intends to access the second service providing server 130′ through the client 100, the following operations are performed.

Firstly, the user transmits an access request message to the second service providing server 130′ through the client 100 (S750).

Next, the second service providing server 130′ transmits an authentication request message to the client 100 (S752).

Next, the client 100 transmits the user identification information and the access permission message to the second service providing server 130′ (S754).

Next, the second service providing server 130′ determines whether or not the time restriction interval for the access permission message has elapsed. If it is determined that the time restriction interval has not elapsed, the second service providing server 130′ transmits a new second access permission message to the client 100 (S756). As a result, the client 100 can access the second service providing server 130′. Here, after the time restriction interval elapsed, user identification information registration checking must be performed by the integrated server 140.

Next, the client 100 updates the first access permission message with a new second access permission message and stores the new second access permission message in the memory 205 (S758).

On the other hand, after operation S754, the second service providing server 130′ determines whether or not the time restriction interval for the first access permission message has elapsed. If it is determined that the time restriction interval has elapsed, the second service providing server 130′ transmits the user identification information to the integrated server 140 to request the user biometric information registered in the integrated server 140 (S760).

Next, the integrated server 140 searches the database 150 to load the user biometric information stored therein so as to check if it matches with the user identification information and regenerates a user biometric information from the loaded user biometric information through a regeneration scheme different from the regeneration scheme used in operation S708 (S762).

Next, the integrated server 140 transmits the regenerated user biometric information and the regeneration scheme to the client (S764).

Next, the second service providing server 130′ transmits a user biometric information input request message to the client (S766). Here, the user biometric information input request message includes the regeneration scheme transmitted in operation S762.

Next, the client 100 regenerates the user biometric information according to the regeneration scheme transmitted in operation S766 (S768).

Next, the client 100 transmits the regenerated user biometric information through the network 120 to the second service providing server 130′ (S770).

Next, the second service providing server 130′ compares the regenerated user biometric information transmitted from the integrated server 140 in operation S764 to the regenerated user biometric information transmitted from the client 100 in operation S770 and performs verification (S772).

Next, when the verification is successful in operation S772, the second service providing server 130′ generates a second access permission message and transmits the generated second access permission message to the client 100, so that the client 100 is authenticated (S774).

Next, the client 100 updates the second access permission message with a new access permission message and stores the new access permission message in the memory 205 (S776).

Subsequently, when the user intends to access other service providing servers through the client 100, the aforementioned operations are repeated.

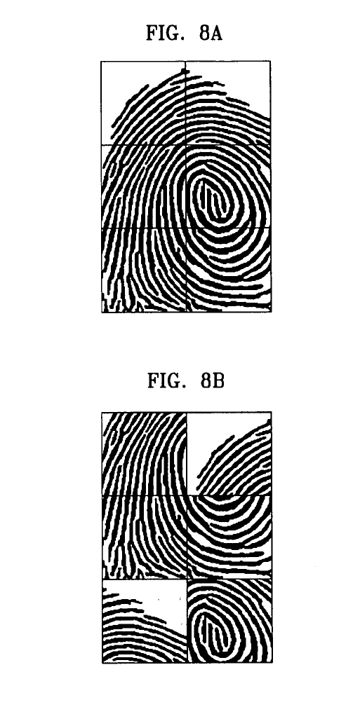

FIGS. 8A and 8B show an example of biometric information regeneration used for fingerprint recognition, which is an example of the biometrics used in FIGS. 2B or 7A and 7B.

Referring to FIG. 8A, an original fingerprint image is divided into specific regions.

Referring to FIG. 8B, new information different from the original fingerprint image is generated by transforming the fingerprint image. In this manner, the new information different from the original fingerprint image is transmitted, so that the original biometric information can be protected.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

According to the present invention, since a user access a plurality of service providing servers by using user biometric information instead of passwords, the user does not need to memorize the passwords, and the access can be performed in a convenient manner.

According to the present invention, since the user biometric information is stored and managed not in a plurality of the service providing servers but in a reliable integrated server, it is possible to prevent loss or theft of the user biometric information and provide high security and reliability.

According to the present invention, since the user accessing an service providing server stores an access permission message in a memory of a client and use the access permission message to access other service providing servers, the user can access the other service providing servers without performing an additional authentication process. In addition, since the access permission message has a predetermined time restriction interval, it is possible to prevent other persons from misusing the access permission message.

According to the present invention, when the client tries to access the service providing servers, the integrated server may not perform the authentication, but user biometric information regenerated from the user biometric information stored in the integrated server according to an inverse-transformation-impossible scheme may be transmitted to the service providing servers, so that the authentication processes can be distributed. Accordingly, it is possible to reduce the load on the integrated server and to reduce network traffic.

What is claimed is:

1. A method of registering user identification information from a client in a service providing server using biometrics in an integrated authentication system having the client, the service providing server, and an integrated server, the method comprising:
(a) the service providing server transmitting the user identification information requested by the client to the integrated server and requesting the integrated server to check whether or not the user identification information is registered in the integrated server;
(b) the integrated server transmitting a user biometric information input request message to the client, comparing user biometric information input from the client to user biometric information which is mapped with the user identification information received from the service providing server and registered in the integrated server, and if they are identical, transmitting a user identification information registration checking success message to the service providing server; and
(c) the service providing server registering the user identification information requested by the client.

2. The method of claim 1, wherein the (b) comprises:
(b1) the integrated server transmitting the user biometric information input request message to the client;
(b2) the integrated server receiving the user biometric information, which is acquired using the biometrics, from the client;
(b3) the integrated server comparing the user biometric information, which is mapped with the user identification information received in operation (a) and registered in the integrated server, to the user biometric information received from the client in operation (b2), and determining whether or not they are the same; and
(b4) when it is determined that they are the same, the integrated server transmitting the user identification information registration checking success message to the service providing server.

3. The method of claim 2, further comprising, before the (b1),
the integrated server transmitting a registration request checking message to the client which requests the service providing server to perform registration in the (a) in order to check whether or not the user identification information is really to be registered in the service providing server; and
the client, in response to the registration request checking message, transmitting a registration request success message to the integrated server when the user identification information is really to be registered in the service providing server.

4. The method of claim 1, further comprising (d) the service providing server transmitting to the client a user information registration success message indicating that the user identification information is registered in the service providing server.

5. A method of authenticating access of a client to a service providing server by using biometrics in an integrated authentication system including an integrated server, the client, and the service providing server where user identification information of the client is registered, the method comprising:
(a) the client transmitting the user identification information to the service providing server to request the access to the service providing server;
(b) the service providing server transmitting the user identification information to the integrated server to request the integrated server to check whether or not the user identification information is registered;
(c) the integrated server transmitting a user biometric information input request message to the client, comparing user biometric information input from the client to user biometric information which is mapped to the user identification information transmitted from the service providing server and registered in the integrated server, and if they are the same, transmitting a user identification information registration checking success message to the service providing server; and
(d) the service providing server authenticating the access of the client.

6. The method of claim 5, further comprising (e) the service providing server generating an access permission message and transmitting the access permission message to the client.

7. The method of claim 6, further comprising:
(f) the client receiving the access permission message generated by the service providing server and storing the access permission message; and
(g) the client acquiring authentication of the access to another service providing server by using the access permission message and the user identification information.

8. A method of authenticating access of a client to a service providing server by using biometrics in an integrated authentication system including the client, the service providing server where user identification information of the client is registered, and an integrated server where user biometric information together with the user identification information is registered, the method comprising:
(a) the client transmitting the user identification information to the service providing server to request for the access;
(b) the service providing server transmitting the user identification information to the integrated serer to request the user biometric information;
(c) the integrated server regenerating user biometric information which is mapped to the user identification information and registered and transmitting the regenerated user identification information and a regeneration scheme to the service providing server; and
(d) the service providing server transmitting a user biometric information input request message, comparing the regenerated user biometric information transmitted from the client to the regenerated user biometric information transmitted from the integrated server to determine whether or not authentication succeeds, and authenticating the access of the client if the authentication is successful.

9. The method of claim 8,
wherein the user biometric information input request message includes the regeneration scheme, and
wherein the client regenerates the user biometric information according to the regeneration scheme and transmits the regenerated user biometric information to the service providing server.

10. The method of claim 8, wherein the regeneration scheme is a cancelable biometrics scheme in which inverse transformation is complicated.

11. The method of claim 8, further comprising (e) the service providing server generating the access permission message and transmitting the access permission message to the client.

12. The method of claim 8, further comprising:
(f) the client receiving the access permission message generated by the service providing server and storing the access permission message; and
(g) the client acquiring authentication of the access to another service providing server by using the access permission message and the user identification information.

13. A method of integratedly authenticating access of a client to a plurality of service providing servers by using biometrics in an integrated authentication system having the client, the plurality of service providing servers where user identification information of the client is registered, and an integrated server, the method comprising:
(a) the client acquiring authentication of access to a first service providing server by using the user biometric information and the user identification information through user authentication of the integrated server;
(b) when the access is permitted in the (a), the client receiving a first access permission message generated by the first service providing server and storing the first access permission message; and
(c) the client acquiring authentication of access to a second service providing server by using the first access permission message and the user identification information.

14. The method of claim 13, further comprising (d), when the access is authenticated in the (c), the client receiving a second access permission message generated by the second service providing server and updating the first access permission message.

15. The method of claim 13, wherein the (c) comprises:
(c1) the client transmitting the first access permission message and the user identification information to the second service providing server;
(c2) the second service providing server determining whether or not a predetermined time has elapsed from the time when the first access permission message is generated to the time when the first access permission message is transmitted to the second service providing server;
(c3) when it is determined that the predetermined time has not elapsed in the (c2), the user identification information determining whether or not the user identification information is registered in the second service providing server; and
(c4) when it is determined that the user identification information is registered in the (c3), the second service providing server generating the second access permission message, transmitting the second access permission message to the client, and authenticating the access of the client.

16. The method of claim 13, wherein the (c) comprises:
(c1′) the client transmitting the first access permission message and the user identification information to the second service providing server;
(c2′) the second service providing server determining whether or not a predetermined time has elapsed from the time when the first access permission message is generated to the time when the first access permission massage is transmitted to the second service message is transmitted;
(c3′) when it is determined that the predetermined time has elapsed in the (c2′), the second service providing server transmitting the user identification information to the integrated server to request the integrated server to check whether or not the user identification information is registered;
(c4′) the integrated server transmitting a user biometric information input request message to the client, authenticating the user identification information based on the user biometric information input from the client, and transmitting the user identification information registration checking success message to the second service providing server; and
(c5′) the second service providing server generating a second access permission message, transmitting the second access permission message to the client, and authenticating the access of the client.

17. The method of claim 13, wherein the (a) comprises:
(a1) the client transmitting the user identification information to the first service providing server to request the access;
(a2) the first service providing server transmitting the user identification information to the integrated server to request the integrated server to check whether or not the user identification information is registered;
(a3) the integrated server transmitting a user biometric information input request message to the client, authenticating the user identification information based on the user biometric information input from the user, and transmitting a user identification information registration checking success message to the first service providing server; and
(a4) the first service providing server generating a first access permission message, transmitting the first access permission message to the client, and authenticating the access of the client.

18. The method of claim 13, further comprising, before the (a), mapping the user biometric information acquired by using the biometrics in the client to the user identification information, thereby registering the user identification information in the integrated server.

19. The method of claim 13, further comprising, before the (a):
transmitting the user biometric information acquired by using the biometrics in the client and the user identification information to the integrated server;
the integrated server determining whether or not the user biometric information and the user identification information are registered; and
when it is determined that the user biometric information and the user identification information are not registered, the integrated server mapping the user biometric information to the user identification information and storing a mapping result.

20. The method of claim 13, further comprising, before the (a):
the client transmitting the user identification information to the integrated server and requesting the integrated server to check whether or not the user identification information is registered;
when it is determined that the user identification information is not registered, the integrated server transmitting a user biometric information input request message to the client;
the integrated server receiving an input of the user biometric information acquired from the client; and
the integrated server storing the user biometric information and the user identification information.

21. A method of integratedly authenticating access of a client to a plurality of the service providing servers by using biometrics in an integrated authentication system having the client, the plurality of service providing servers where user identification information of the client is registered, and an integrated server where user biometric information together with the user identification information is registered, the method comprising:
(a) the client acquiring authentication of access to a first service providing server by using the user biometric information and the user identification information through the integrated server;
(b) when the access is permitted in the (a), the client receiving a first access permission message generated by the first service providing server and storing the first access permission message; and
(c) the client acquiring authentication of access to a second service providing server by using the first access permission message and the user identification information.

22. The method of claim 21, further comprising (d), when the access is authenticated in the (c), the client receiving a second access permission message generated by the second service providing server and updating the first access permission message.

23. The method of claim 21, wherein the (c) comprises:
(c1) the client transmitting the first access permission message and the user identification information to the second service providing server;
(c2) the second service providing server determining whether or not a predetermined time has elapsed from the time when the first access permission message is generated to the time when the first access permission message is transmitted to the second service providing server;
(c3) when it is determined that the predetermined time has not elapsed in the (c2), the user identification information determining whether or not the user identification information is registered in the second service providing server; and
(c4) when it is determined that the user identification information is registered in the (c3), the second service providing server generating the second access permission message, transmitting the second access permission message to the client, and authenticating the access of the client.

24. The method of claim 21, wherein the (c) comprises:
(c1′) the client transmitting the first access permission message and the user identification information to the second service providing server;
(c2′) the second service providing server determining whether or not a predetermined time has elapsed from the time when the first access permission message is generated to the time when the first access permission massage is transmitted to the second service message;
(c3′) when it is determined that the predetermined time has elapsed in the (c2′), the second service providing server transmitting the user identification information to the integrated server to request the user biometric information;
(c4′) the integrated server regenerating user biometric information which is mapped to the user identification information and registered and transmitting the regenerated user identification information and a regeneration scheme to the second service providing server;
(c5′) the second service providing server transmitting a user biometric information input request message, comparing the regenerated user biometric information transmitted from the client to the regenerated user biometric information transmitted from the integrated server to authenticate the client, and determining whether or not authentication succeeds; and
(c6′) when it is determined that the authentication is successful, the second service providing server generating a second access permission message, transmitting the second access permission message to the client, and authenticating the access of the client.

25. The method of claim 21, wherein the (a) comprises:
(a1) the client transmitting the user identification information to the first service providing server to request the access;
(a2) the first service providing server transmitting the user identification information to the integrated server to request the user biometric information;
(a3) the integrated server regenerating user biometric information which is mapped to the user identification information and registered and transmitting the regenerated user identification information and a regeneration scheme to the first service providing server;
(a4) the first service providing server transmitting a user biometric information input request message, comparing the regenerated user biometric information transmitted from the client to the regenerated user biometric information transmitted from the integrated server, and determining whether or not the authentication succeeds; and
(a5) when it is determined that the authentication is successful, the first service providing server generating a first access permission message, transmitting the first access permission message to the client, and authenticating the access of the client.

26. The method of claim 25,
wherein the user biometric information input request message includes the regeneration scheme, and
wherein the client regenerates the user biometric information according to the regeneration scheme and transmits the regenerated user biometric information to the service providing server.

27. The method of claim 26, wherein the regeneration scheme is a cancelable biometrics scheme in which an inverse transformation is complicated.

28. The method of claim 21, further comprising, before the (a), mapping the user biometric information acquired by using the biometrics in the client to the user identification information, thereby registering the user identification information in the integrated server.

29. The method of claim 21, further comprising, before the (a):
transmitting the user biometric information acquired by using the biometrics in the client and the user identification information to the integrated server;
the integrated server determining whether or not the user biometric information and the user identification information are registered; and
when it is determined that the user biometric information and the user identification information are not registered, the integrated server mapping the user biometric information to the user identification information and storing a result of the mapping.

30. The method of claim 21, further comprising, before the (a):
the client transmitting the user identification information to the integrated server and requesting the integrated server to check whether or not the user identification information is registered;
when it is determined that the user identification information is not registered, the integrated server transmitting a user biometric information input request message to the client;
the integrated server receiving an input of the user biometric information acquired from the client; and
the integrated server storing the user biometric information and the user identification information.

31. An integrated authentication system using biometrics comprising:
a client receiving the user identification information and an input of user biometric information through a biometric information input machine, transmitting the user biometric information and the user identification information to the integrated server to acquire registration, and having access to the service providing server by using the user identification information;
a service providing server checking whether or the user identification information is stored in the integrated server when the access request message including the user identification information is transmitted from the client and, after the checking, authenticating the access of the client; and
an integrated server registering the user biometric information and the user identification information transmitted from the client, requesting the client to input the user biometric information when a user identification information checking request message is transmitted from the service providing server, comparing the user biometric information input from the client to user biometric information stored in the integrated server to authenticate the client, and when authentication succeeds, transmitting a user identification information checking success message to the service providing server.

32. The integrated authentication system of claim 31, wherein the service providing server receives the user identification information checking success message from the integrated server, and when the access of the client is authenticated, generates an access permission message, and transmits the access permission message to the client.

33. The integrated authentication system of claim 32, wherein the client, after receiving the access permission message from the service providing server, transmits the access permission message and the user identification information to another service providing server different from the service providing server to acquire authentication of access.

34. The integrated authentication system of claim 33, wherein the different service providing server determines whether or not a predetermined time has elapsed from the time when the access permission message is generated to the time when the access permission message is transmitted to the different service providing server and determines whether or not the user identification information is registered in the different service providing server when it is determined that the predetermined time has not elapsed, and authenticating the access of the client.

35. The integrated authentication system of claim 34, wherein, when the access of the client is authenticated, the different service providing server generates a new access permission message and transmits the new access permission message to the client.

36. The integrated authentication system of claim 33, wherein the different service providing server determines whether or not a predetermined time has elapsed from the time when the access permission message is generated to the time when the access permission message is transmitted to the different service providing server, transmits a user identification information checking request message to check whether or not the user identification information is stored in the integrated server when it is determined that the predetermined time has elapsed, and authenticates the access of the client when a user identification information checking success message is transmitted from the integrated server.

37. An integrated authentication system using biometrics comprising:
a client transmitting to the integrated server the user identification information and user biometric information matching with the user identification information to acquire registration and accessing the service providing server by using the user identification information;
an integrated server detecting the user biometric information matching with the user identification information and regenerating user biometric information when a user biometric information request message including the user identification information is transmitted, and transmitting the regenerated user biometric information to the service providing server; and
a service providing server transmitting the user identification information to the integrated server when an access request message including the user identification information is transmitted, comparing the regenerated user biometric information transmitted from the integrated server to user biometric information regenerated according to a regeneration scheme that is the same as a regeneration scheme transmitted from the client by request, and authenticating the access of the client.

38. The integrated authentication system of claim 37, wherein, when the access of the client is authenticated, the service providing server generates an access permission message and transmits the access permission message to the client.

39. The integrated authentication system of claim 38, wherein the client receiving the access permission message from the service providing server transmits the access permission message and user identification information associated with another service providing server different from the service providing server to the different service providing server to acquire authentication of access.

40. The integrated authentication system of claim 39, wherein the different service providing server determines whether or not a predetermined time has elapsed from the time when the access permission message is generated to the time when the access permission message is transmitted to the different service providing server and determines whether or not the user identification information is registered in the different service providing server when it is determined that the predetermined time has not elapsed, and authenticating the access of the client.

41. The integrated authentication system of claim 40, wherein, where the access of the client is authenticated, the different service providing server generates a new access permission message and transmits the new access permission message to the client.

42. The integrated authentication system of claim 37,
wherein the user biometric information input request message includes the regeneration scheme, and
wherein the client regenerates the user biometric information according to the regeneration scheme and transmits the regenerated user biometric information to the service providing server.

43. The method of claim 42, wherein the regeneration scheme is a cancelable biometrics scheme in which an inverse transformation is complicated.
